(19) United States
(12) Patent Application Publication
(10) Pub. No.: US 2023/0320377 A1
(43) Pub. Date: Oct. 12, 2023

(54) SEAFOOD PASTE PRODUCT-LIKE FOOD AND METHOD FOR PRODUCING SAME, SEAFOOD PASTE PRODUCT-LIKE INSTANT FOOD MATERIAL AND METHOD FOR PRODUCING SAME

(71) Applicant: FUJI OIL HOLDINGS INC., Osaka (JP)

(72) Inventor: Shinichiro NAGATOMO, Ibaraki (JP)

(73) Assignee: FUJI OIL HOLDINGS INC., Osaka (JP)

(21) Appl. No.: 18/022,513

(22) PCT Filed: Sep. 15, 2021
(86) PCT No.: PCT/JP2021/033876

§ 371 Date: Feb. 22, 2023

(30) Foreign Application Priority Data
Sep. 29, 2020 (JP) 2020-163646
Dec. 17, 2020 (JP) 2020-209078
Feb. 16, 2021 (JP) 2021-022440

(51) Int. Cl. A23J 3/16; A23J 3/22; A23L 29/269; A23L 29/00; A23P 30/10

(52) U.S. Cl. CPC A23J 3/16; A23J 3/225; A23L 29/272; A23L 29/035; A23P 30/10

(57) ABSTRACT

A kamaboko-like food having a good texture can be produced by preparing a paste by mixing 1 to 20% by weight of a powdery vegetable protein, 1 to 8% by weight of gellan gum, 0.005 to 0.15% by weight of a divalent metal salt as a divalent metal, and 60 to 95% by weight of water, and molding and heating the paste. The powdery vegetable protein is preferably soybean protein. Additionally, the paste may also be molded uniformly to a thickness of 5 mm or less. By using this paste, a crab-flavored kamaboko-like food, which has many process restriction, can be produced.

### TECHNICAL FIELD

The present invention relates to a seafood paste product-like food (e.g., kamaboko-like food) that does not use minced meat of fish and shellfish, and a method for producing the same.

### RELATED ART

Seafood paste products such as kamaboko and chikuwa are widely consumed in the Japanese diet. Furthermore, in recent years, they have been attracting attention for enabling people to easily ingest high-quality protein.

The price of minced meat of fish and shellfish, which are the main raw materials of seafood paste products, fluctuates due to the supply-demand balance, so stabilizing raw material costs has long been an issue. In recent years, especially from the aspect of environmental protection, saving seafood resources has become one of the important social issues. Furthermore, due to various considerations including environmental and health aspects, there is a growing preference for plant-based foods as well as an accompanying increase in the population of vegetarians and vegans, and the need for the corresponding foods is also increasing worldwide. There is also a demand for seafood paste products that have the same texture, appearance, and flavor but do not use fish, shellfish, or minced meat made from these ingredients as much as possible.

Among seafood paste products, the texture required for kamaboko, for example, includes moderate hardness, elasticity, suppleness, and texture with good chewability and crispness. Patent Document 1 describes a method for producing a kamaboko-like food using heat-coagulable protein (egg white, soybean), tapioca starch, polysaccharide thickener (carrageenan, psyllium), edible oil, and water without using fish meat, but there was still room for further improvement in terms of the kamaboko-like texture.

Vegetable protein represented by powdery soybean protein is a raw material widely used in seafood paste products (e.g., Patent Document 2 and Patent Document 3). It is often used to improve the physical properties and texture of minced meat, or to reduce costs by partially replacing minced meat.

Gellan gum is an example of a raw material used to improve the physical properties and texture of seafood paste products. Patent Document 4 and Patent Document 5 describe that gellan gum can be added to produce seafood paste products with elasticity. Further, gellan gum comes in a native type in addition to the normal type (deacylated type) (Non-Patent Document 1). Patent Document 6 is an application relating to a seafood paste product produced by heating and dissolving a native-type gellan gum in water to make a paste, and adding 0.1 to 1.5% by weight of the paste with respect to the minced fish meat, and it is described that it has good elasticity and freeze resistance. All of these describe adding together with minced meat to contribute to the physical properties, and do no suggest formulations or production methods that do not use minced meat.

In addition, among kamabokos, the “crab-flavored kamaboko”, for example, is a representative product of flavored kamabokos. The crab-flavored kamaboko is typically produced by the chopping method and the noodle-making method, and the noodle-making method produces a good texture (Non-Patent Document 2, Non-Patent Document 3, Patent Document 7, Patent Document 8). Since the noodle-making method includes a step of thinly stretching the paste before heating, the paste needs to have the property of being moderately stretched to form a film, i.e., film formability. Furthermore, in actual machine production, this sheet (film)-shaped paste is gelled in a short time by heating with a drum-type steamer, and the sheet should be easily peeled off from the drum after heating, so multifaceted physical properties and quality such as sheet tensile strength are required. However, even with general seafood paste products, the moderate elasticity and physical properties largely depend on the quality and formulation of the minced meat, and it was even more difficult to obtain such physical properties without using minced meat.

### RELATED ART DOCUMENTS

### Patent Documents

Patent Document 1: Japanese Patent Application Laid-Open No. 115-153915
Patent Document 2: Japanese Patent Application Laid-Open No. S53-88354
Patent Document 3: Japanese Patent Application Laid-Open No. S62-25953
Patent Document 4: Japanese Patent Application Laid-Open No. S63-169964
Patent Document 5: Japanese Patent Application Laid-Open No. H5-260933
Patent Document 6: Japanese Patent Application Laid-Open No. 2000-23640
Patent Document 7: Japanese Patent Application Laid-Open No. S60-224471
Patent Document 8: Japanese Patent Application Laid-Open No. S60-160861

### Non-Patent Documents

Non-Patent Document 1: “Food and Container”, vol. 53, No. 11 (2012) p. 676
Non-Patent Document 2: “New Revised Science of Kamaboko”, p. 101-104, Seizando Bookstore, Jul. 18, 2008
Non-Patent Document 3: “Kamaboko: Its Science and Technology”, p. 174-176, Kouseisha Kouseikaku, Dec. 10, 2003

### SUMMARY OF INVENTION

### Problems to be Solved by Invention

An objective of the present invention is to provide a seafood paste product-like food with texture and physical properties comparable to products using minced meat.

### Means to Solve Problems

The inventor of the present invention has diligently studied the above problems and has found that, by formulating a powdery vegetable protein, gellan gum, a divalent metal salt, and water in specific ranges in a paste, it is possible to produce a kamaboko-like food and even a crab-flavored kamaboko-like food which has many process restrictions, thus completing the present invention.

That is, the present invention includes the following.

(1) A method for producing a seafood paste product-like food includes preparing a paste containing 1 to 20% by weight of a powdery vegetable protein, 1 to 8% by weight of gellan gum, 0.005 to 0.15% by weight of a divalent metal salt as a divalent metal, and 60 to 95% by weight of water, and molding and heating the paste.

(2) In the method for producing a seafood paste product-like food according to (1), minced meat is not contained.

(3) In the method for producing a seafood paste product-like food according (1) or (2), the paste further contains 1 to 10% by weight of starch.

(4) In the method for producing a seafood paste product-like food according to any one of (1) to (3), the paste further contains 0.1 to 3% by weight of dietary fiber.

(5) In the method for producing a seafood paste product-like food according to any one of (1) to (4), the paste further contains 1 to 10% by weight of fat and oil.

(6) The method for producing a seafood paste product-like food according to any one of (1) to (5) includes a molding step of stretching the paste to a thickness of 5 mm or less.

(7) A seafood paste product-like food contains a powdery vegetable protein, gellan gum, and a divalent metal and does not contain minced meat.

(8) A method for producing a seafood paste product-like instant food material includes preparing a paste containing 1 to 20% by weight of a powdery vegetable protein, 1 to 8% by weight of gellan gum, 0.005 to 0.15% by weight of a divalent metal salt as a divalent metal, and 60 to 95% by weight of water, and molding, heating, and drying the paste.

(9) A seafood paste product-like instant food material contains a powdery vegetable protein, gellan gum, and a divalent metal and does not contain minced meat.

### Effects of Invention

According to the present invention, it is possible to provide a food in response to the diversification of diet while contributing to economization of seafood resources, which is one of the social issues.

### DESCRIPTION OF EMBODIMENTS

The present invention will be specifically described below.

(Seafood Paste Product, Seafood Paste Product-Like Food)

A so-called seafood paste product is produced by adding various auxiliary materials such as salt and, if necessary, seasonings, starch, and vegetable protein into minced meat of fish and shellfish, and kneading, molding, and heating these materials in known methods. Specific examples include kamaboko, crab-flavored kamaboko, deep-fried kamaboko, chikuwa, hanpen, and fish balls.

In the present invention, a food having the same texture, appearance, and flavor as the foods above but with a significantly reduced formulated amount of the minced meat or with no minced meat will be referred to as a “seafood paste product-like food”. In the present invention, depending on the type of individual products, such a food will be referred to in the form of, for example, a “kamaboko-like food” corresponding to a general “kamaboko” using minced meat.

(Powdery Vegetable Protein)

The powdery vegetable protein used in the present invention may be appropriately selected from commercially available products produced from vegetable raw materials such as soybean, wheat, and peas. Powdery soybean protein made from soybean as raw material is particularly preferable.

The powdery vegetable protein may be appropriately selected from commercially available products that are used in general seafood paste products, depending on the desired physical properties, flavor, and color tone. Its formulated amount in the paste is 1% by weight or more and 20% by weight or less, preferably 2 to 18% by weight, and more preferably 2 to 15% by weight. If the formulated amount is less than this, moderate water retention, hardness, and texture may not be obtained. If the formulated amount is more than this, hardness or elasticity of the food may be too high.

Further, by increasing its formulated amount, it is possible to design a product as a convenient and high-quality protein supply source.

(Gellan Gum)

Gellan gum is a polysaccharide produced by a non-pathogenic microorganism, Sphingomonas elodea, and comes in two types including a deacylated type and a native type. In the present invention, the native-type gellan gum is suitable and may be appropriately selected from commercially available products for use. Its formulated amount in the paste is 1% by weight or more and 8% by weight or less, preferably 1.3 to 6% by weight, and more preferably 1.6 to 5% by weight. If the formulated amount is less than this, the preferable texture, specifically hardness, elasticity, suppleness, and good crispness, of a seafood paste product may not be obtained. If the formulated amount is more than this, it may be difficult to prepare the paste due to an overly high elasticity, or an undesirable rubber-like texture may be produced.

(Divalent Metal)

By adding a divalent metal in the present invention, it is possible to impart moderate hardness, elasticity, and good crispness, which are preferable texture in a seafood paste product-like food. It is desirable to use a divalent metal salt, and specific examples include calcium salt and magnesium salt, with calcium salt being desirable from the perspective of flavor. Examples of calcium salt include calcium sulfate, calcium lactate, calcium chloride, and calcium carbonate, desirably calcium lactate, calcium sulfate, and calcium chloride, and more desirably calcium lactate.

The amount the divalent metal added in the paste is desirably 0.005% by weight or more and 0.15% by weight or less, preferably 0.01 to 0.1% by weight, and more preferably 0.015 to 0.08% by weight.

In the case where calcium lactate (pentahydrate) for food is used, it may be appropriately adjusted to about 0.1 parts by weight with respect to 1 part by weight of gellan gum. Its formulated amount in the paste is 0.05 to 1.0 part by weight, preferably 0.1 to 0.7 parts by weight, and more preferably 0.15 to 0.6 parts by weight. If the formulated amount is less than this, the texture may be sticky due to lack of elasticity, and if the formulated amount is more than this, the flavor may be affected.

(Water)

In the present invention, tap water and any other water commonly used for food production such as distilled water and ion-exchanged water may be used. The temperature of the water is not particularly limited, but it is preferable to keep the temperature below room temperature, since the raw materials may become lumpy when mixed at a high temperature. Cold water or ice water may be added.

Its formulated amount may be appropriately adjusted depending on the type, composition, and properties of the powdery vegetable protein to be used, and is 60% by weight or more and 95% by weight or less in the paste, preferably 65 to 90% by weight, and more preferably 65 to 80% by weight. If the amount of water is less than this, the texture will be too hard, and if the amount is more than this, the texture will be too soft, and the preferable texture as a seafood paste product-like food may not be obtained.

(Starch)

In the present invention, by further adding starch, it becomes easier to obtain moderate shape retention and hardness. Any starch that is commonly used for seafood paste products may be used as the starch herein. For example, one or more types selected from tapioca starch, potato starch, pea starch, wheat starch, corn starch, and/or processed starches thereof may be used alone or in combination as appropriate.

Its formulated amount in the paste is 1% by weight or more and 10% by weight or less, preferably 1 to 8% by weight, and more preferably 2 to 7% by weight. If the formulated amount is less than this, the effects described above may not be obtained sufficiently. On the other hand, if the formulated amount is more than this, the texture derived from starch becomes too strong, and it may be difficult to obtain the preferable texture as a seafood paste product-like food.

(Dietary Fiber)

By further adding dietary fiber into the paste of the present invention, it is possible to obtain a better texture, specifically moderate chewability and good crispness. Insoluble dietary fibers such as cellulose and oat fiber are preferable, and oat fiber is more preferable. The oat fiber in the present invention refers to the so-called bran portion of oat, that is, the insoluble fiber portion obtained by removing water-soluble components such as water-soluble fiber from the outer skin portion.

Its formulated amount in the paste is 0.1% by weight or more and 3% by weight or less, preferably 0.2 to 2% by weight, more preferably 0.3 to 1.5% by weight. If the formulated amount is less than this, the effect of improving the texture may be insufficient, and if the formulated amount is more than this, the texture may become powdery.

(Fat and Oil)

In the present invention, by further adding fat and oil, it becomes easier to obtain more preferable color tone and texture. The type of fat and oil is not particularly limited, and any of edible fats and oils such as soybean oil, rapeseed oil, corn oil, palm oil, coconut oil, safflower oil, olive oil, cottonseed oil, and sunflower oil may be used. Fats and oils that are liquid at room temperature are preferable in consideration of the emulsifiability at the time of making the paste and the texture at the time of eating.

When added, its amount in the paste is 1% by weight or more and 10% by weight or less, preferably 2 to 9% by weight, and more preferably 3 to 7% by weight. If the amount is more than this, the shape of the paste may not be retained after heating, and the paste may sag and spread. In the case of designing a product with low oil content, the formulated amount may be small or fat and oil may not be added at all.

The procedure for mixing fat and oil into the paste suitably precedes the addition of salt. If fat and oil is mixed after the salt, the emulsification/dispersion in the paste may be insufficient and a good paste may not be obtained. It is efficient and preferable to mix fat and oil at the same time with other main raw materials other than salt.

(Salt)

Salt may be added in the same manner as in general seafood paste products using minced meat, and as a rough guideline, may be 0.5 to 2.5% by weight in the paste, for example. Since salt may affect the solubility and emulsifiability of the vegetable protein if mixed at the same time with the powdery vegetable protein in the formulated raw materials, it is desirable to add salt after the vegetable protein is uniformly dissolved and dispersed in the paste.

(Other Raw Materials)

In addition to the above, the present invention may include any of raw materials such as sugars, sake/mirin, various seasonings, fragrances, pigments, etc. that are added in general seafood paste products, as long as they do not impair the effects of the present invention.

(Minced Meat)

With seafoods such as fish meat and shellfish serving as raw materials, minced meat is produced by performing washing, soaking in water, refining by removing impurities by draining, and dehydrating on such raw materials. According to the method of the present invention, even if the amount of minced meat used is greatly reduced or even not contained at all, and even if none of animal raw materials such as egg whites, powdery egg whites, livestock meat, and dairy products is contained, it is possible to produce a food having a texture equivalent to that of general seafood paste products. In the present invention, “not contain” means that the ingredient is not added as a raw material, excluding cases such as minute amounts of contamination in the production process.

Further, according to the method of the present invention, it is possible to realize a texture similar to fish and shellfish such as squid and octopus in addition to seafood paste product-like foods, by adjusting variety selections and formulation ratios of raw materials.

(Preparation of Paste)

The procedure for preparing the paste may be exemplified below. First, predetermined amounts of powdery vegetable protein, water, and seasonings other than salt are placed in a mixing container and uniformly mixed. It is desirable to use an apparatus with a shearing force for mixing, such as Robot-Coupe, Silent Cutter, and Ball Cutter, for example. As a rough guideline, the mixing time may be about 2 to 10 minutes, for example. Subsequently, salt is further added and mixed for about 2 to 10 minutes to obtain the paste.

(Molding)

The paste is molded according to the desired shape. The molding method may follow a conventional method for producing general seafood paste products, and may be performed manually or using a general molding machine. Examples of the molding machine include a casing filling machine, a deep-fried kamaboko molding machine, a plate-attached kamaboko molding machine, and a chikuwa molding machine.

In the case of producing a crab-flavored kamaboko-like food, the method may include, for example, uniformly stretching the paste to a thickness of 5 mm or less, preferably 4 mm or less, and more preferably 2 mm or less, and heating, shredding into a fiber shape, and bundling.

(Heating)

The molded paste is heated using any means such as steaming, frying, baking, and steam-frying. Retort heating may also be performed. The heating conditions are 70° C. or higher for 1 minute or longer, preferably 70° C. to 180° C. for 1 to 60 minutes, more preferably 75 to 130° C., and most preferably 80 to 122° C. for 1 to 50 minutes.

(Instant Food Material)

The seafood paste product-like food of the present invention has the quality of being easily reconstituted with hot water even when dried. Accordingly, the food may be used as a preserved food as it is, or may be suitably used as a material for instant food such as soup and noodles. The drying means may be a commonly known method, and examples thereof include freeze drying, flash drying, hot air drying, microwave drying, and vacuum fry drying.

The following examples are provided to illustrate the present invention in more detail.

(Review 1)

Raw materials other than salt were mixed in a Robot-Coupe (rotational speed: 1500 rpm; time: 5 minutes) according to the formulations shown in Table 1-1 and Table 1-2 (unit: % by weight). Salt was added thereto and mixed for 5 minutes. The obtained paste was vacuum degassed, packed in a casing having a folded diameter of 30 mm, and heated (steamed) at 90 to 95° C. for 20 minutes to obtain a kamaboko-like food. The following products were used as the raw materials.
Powdery soybean protein A: Fujipro 748 (manufactured by Fuji Oil Co., Ltd.)
Powdery soybean protein B: New Fujipro 001M (manufactured by Fuji Oil Co., Ltd.)
Gellan gum: Kelcogel LT-100 (by CP Kelco, native type)
Oil: Rapeseed refined oil (manufactured by Fuji Oil Co., Ltd.)
Calcium lactate: pentahydrate, food additive (by Kishida Chemical), pre-dissolved in some water and mixed

(Sensory Evaluation Criteria)

Sensory evaluation was carried out by five skilled panelists to comprehensively evaluate the kamaboko-like texture, and determination was made by discussion.
⊚: Not inferior to general kamaboko, particularly good
◯: Good as a kamaboko-like food without problem
Δ: Slightly inferior, but within the range of kamaboko-like food
x: There is a sense of incongruity and inappropriateness as kamaboko-like food

The formulations and evaluation results are shown in Table 1-1 and Table 1-2. In the examples, the texture changes depending on the formulation, but all of them might be said to be within the range of kamaboko-like foods. On the other hand, the hardness and elasticity of Comparative Examples 1 and 3 were determined to be out of the category of kamaboko-like foods, and the paste of Comparative Example 2 was not cured in the first place and could not be evaluated.

TABLE 1-1

| | Example | Example | Example | Example | Example | Example | Example | Example |
|---|---|---|---|---|---|---|---|---|
| | 1 | 2 | 3 | 4 | 5 | 6 | 7 | 8 |
| Powdery | 6.0 | 4.0 | 9.0 | — | 6.0 | 6.0 | 6.0 | 6.0 |
| soybean | | | | | | | | |
| protein A | | | | | | | | |
| Powdery | — | — | — | 6.0 | — | — | — | — |
| soybean | | | | | | | | |
| protein B | | | | | | | | |
| Gellan | 4.5 | 4.5 | 4.5 | 4.5 | 4.0 | 3.0 | 2.5 | 4.5 |
| gum | | | | | | | | |
| Calcium | 0.4 | 0.4 | 0.4 | 0.4 | 0.4 | 0.2 | 0.2 | — |
| lactate | | | | | | | | |
| Calcium | — | — | — | — | — | — | — | 0.4 |
| chloride | | | | | | | | |
| Oil | 6.0 | 6.0 | 6.0 | 6.0 | 6.0 | 6.0 | 6.0 | 6.0 |
| Tapioca | 5.2 | 5.2 | 5.2 | 5.2 | 5.2 | 5.2 | 5.2 | 5.2 |
| starch | | | | | | | | |
| Oat fiber | 0.6 | 0.6 | 0.6 | 0.6 | 0.6 | 0.6 | 0.6 | 0.6 |
| Sugar | 3.0 | 3.0 | 3.0 | 3.0 | 3.0 | 3.0 | 3.0 | 3.0 |
| Seasoning | 0.3 | 0.3 | 0.3 | 0.3 | 0.3 | 0.3 | 0.3 | 0.3 |
| Water | 73.0 | 75.0 | 70.0 | 73.0 | 73.5 | 74.7 | 75.2 | 73.0 |
| Salt | 1.0 | 1.0 | 1.0 | 1.0 | 1.0 | 1.0 | 1.0 | 1.0 |
| Total | 100.0 | 100.0 | 100.0 | 100.0 | 100.0 | 100.0 | 100.0 | 100.0 |
| Sensory | ⊚ | ⊚ | ◯-Δ | ⊚ | ◯ | ◯ | Δ | ⊚ |
| evaluation | | | | | | | | |
| Remark | Moderate | Moderate | Slightly | Moderate | Moderate | Moderate | Slightly | Moderate |
| | hardness | hardness | poor | hardness | hardness | hardness | poor | hardness |
| | and | and | elasticity | and | and | and | elasticity | and |
| | elasticity | elasticity | | elasticity | elasticity | elasticity | | elasticity |

TABLE 1-2

| | Example | Example | Example | Example | Example | Comparative | Comparative | Comparative |
|---|---|---|---|---|---|---|---|---|
| | 9 | 10 | 11 | 12 | 13 | Example 1 | Example 2 | Example 3 |
| Powdery | 6.0 | 6.0 | 6.0 | 6.0 | 7.0 | 6.0 | 6.0 | — |
| soybean | | | | | | | | |
| protein A | | | | | | | | |
| Gellan | 4.5 | 4.5 | 4.5 | 4.5 | 4.5 | 4.5 | — | 4.5 |
| gum | | | | | | | | |
| Calcium | 0.4 | 0.4 | 0.4 | 0.4 | 0.4 | — | 0.4 | 0.4 |
| lactate | | | | | | | | |
| Oil | 6.0 | 6.0 | 6.0 | 6.0 | 6.0 | 6.0 | 6.0 | 6.0 |
| Tapioca | — | — | — | 5.2 | 5.2 | 5.2 | 5.2 | 5.2 |
| starch | | | | | | | | |
| Potato | 5.2 | — | — | — | — | — | — | — |
| starch | | | | | | | | |
| Pea starch | — | 5.2 | — | — | — | — | — | — |
| Oat fiber | 0.6 | 0.6 | 0.6 | 1.1 | — | 0.6 | 0.6 | 0.6 |
| Sugar | 3.0 | 3.0 | 3.0 | 3.0 | 3.0 | 3.0 | 3.0 | 3.0 |
| Seasoning | 0.3 | 0.3 | 0.3 | 0.3 | 0.3 | 0.3 | 0.3 | 0.3 |
| Water | 73.0 | 73.0 | 78.2 | 72.5 | 72.6 | 73.4 | 77.5 | 79.0 |
| Salt | 1.0 | 1.0 | 1.0 | 1.0 | 1.0 | 1.0 | 1.0 | 1.0 |
| Total | 100.0 | 100.0 | 100.0 | 100.0 | 100.0 | 100.0 | 100.0 | 100.0 |
| Sensory | ◯ | ⊚ | ◯-Δ | ◯-Δ | ◯-Δ | X-Δ | X | X-Δ |
| evaluation | | | | | | | | |
| Remark | Slightly | Good | Slightly | Soft but | Slightly | Hard and | Still | Strong |
| | brittle but | hardness | strong | good | too sticky | brittle, and | liquid and | elasticity |
| | moderate | and | hardness | crispness | | poor | not gelled | and hard |
| | hardness | crispness | and | | | elasticity | | texture |
| | and | | elasticity | | | and | | |
| | elasticity | | | | | suppleness | | |

(Review 2)

With the formulations of Examples 1 and 2, the heating means was replaced with retort heating (121° C. for 15 minutes) in the production. Almost no deterioration in the texture was observed, and it was confirmed that there was no problem with the quality.

(Review 3)

According to the formulations of Table 2, the paste was prepared according to the same procedure as Review 1. The obtained paste was vacuum degassed, and then was applied to a 1 mm-thick mold and stretched. Whether the paste could be uniformly stretched and molded was defined as “film formability” and was evaluated from the following perspective.
⊚ Easily formable, especially good
◯ Good
ΔA Highly elastic and difficult

TABLE 2
Formulations and evaluation results of Review 3

| | Example 14 | Example 15 | Example 16 | Example 17 |
|---|---|---|---|---|
| Powdery | 6.0 | 6.0 | 6.0 | 6.0 |
| soybean protein | | | | |
| B | | | | |
| Gellan gum | 2.1 | 2.4 | 2.7 | 4.0 |
| Calcium lactate | 0.2 | 0.2 | 0.2 | 0.2 |
| Oil | 6.0 | 6.0 | 6.0 | 6.0 |
| Pea starch | 5.2 | 5.2 | 5.2 | 5.2 |
| Oat fiber | 0.6 | 0.6 | 0.6 | 0.6 |
| Sugar | 3.0 | 3.0 | 3.0 | 3.0 |
| Seasoning | 0.4 | 0.4 | 0.4 | 0.4 |
| Water | 75.5 | 75.2 | 74.9 | 73.6 |
| Salt | 1.0 | 1.0 | 1.0 | 1.0 |
| Total | 100.0 | 100.0 | 100.0 | 100.0 |
| Film formability | ⊚ | ◯ | ◯ | Δ |
| evaluation | | | | |

(Review 4) Review on Type of Protein

In the formulated raw materials of Example 14, “powdery soybean protein B” was replaced with another powdery vegetable protein, a paste was similarly prepared and molded, and film formability was evaluated.

According to the results shown in Table 3, film formation was possible in all examples. However, with powdery vegetable proteins other than the powdery soybean protein, there were problems with the color tone and texture after heating, and it was determined that soybean-derived vegetable protein is suitable in the present invention.

TABLE 3
Details and evaluation of Review 4

| | | Example | Example | Example | Example | Example | Example |
|---|---|---|---|---|---|---|---|
| | | 18 | 19 | 20 | 21 | 22 | 23 |
| Raw material of | | Soybean | Soybean | Broad | Pea | Wheat | Wheat |
| powdery vegetable | | | | bean | | | |
| protein | | | | | | | |
| Manufacturer | | Fuji Oil | ADM | Organo | Dupont | Glico | Glico |
| Product name | | Fujipro | Arcon S | Broad | PP-CS | Nutrition | Nutrition |
| | | 748 | (soybean | bean | | A-glu G | A-glu K |
| | | (soybean | protein | protein | | | |
| | | protein | concentrate) | | | | |
| | | isolate) | | | | | |
| Film formability | | ⊚ | ◯ | Δ-◯ | O | ⊚ | ⊚ |
| Evaluation | Color | White | White | Yellowish | Yellowish | White | Yellowish |
| after | tone | | | brown | brown | | brown |
| heating | Texture | Good | Slightly | Rough | Rough | Rough | Rough |
| | | | rough | | | | |

(Review 5)

Using the formulations (Examples 14 to 16) having film formability being ⊚ and ◯ 5 in Review 3 (Table 2), crab-flavored kamaboko-like foods were produced (noodle-making method) using a general crab-flavored kamaboko producing apparatus, and production line suitability and quality were confirmed. The production apparatus flow is as follows.

Ball cutter/meat feed pump/molding machine/drum steamer/cooling conveyor/fiber shredder/fiber bundling machine/applying machine/packaging cutting machine/heating machine

As a result, in any of the examples, there were no problems with the film formability of the paste, the peelability or tensile strength of the sheet at the production line, and products equivalent in appearance and texture to general crab-flavored kamabokos were obtained.

(Review 6)

The crab-flavored kamaboko-like foods obtained in Review 5 were freeze-dried by a conventional method, and were reconstituted with hot water and restored to their original state in three minutes. It was confirmed that they were also suitable as instant food materials and dry ingredients for instant foods.

1. A method for producing a seafood paste product-like food, comprising:
preparing a paste containing 1 to 20% by weight of a powdery vegetable protein, 1 to 8% by weight of gellan gum, 0.005 to 0.15% by weight of a divalent metal salt as a divalent metal, and 60 to 95% by weight of water, and molding and heating the paste.

2. The method for producing a seafood paste product-like food according to claim 1, wherein minced meat is not contained.

3. The method for producing a seafood paste product-like food according to claim 1, wherein the paste further contains 1 to 10% by weight of starch.

4. The method for producing a seafood paste product-like food according to claim 1, wherein the paste further contains 0.1 to 3% by weight of dietary fiber.

5. The method for producing a seafood paste product-like food according to claim 1, wherein the paste further contains 1 to 10% by weight of fat and oil.

6. The method for producing a seafood paste product-like food according to claim 1, comprising a molding step of stretching the paste to a thickness of 5 mm or less.

7. A seafood paste product-like food, which contains a powdery vegetable protein, gellan gum, and a divalent metal and does not contain minced meat.

8. A method for producing a seafood paste product-like instant food material, comprising:
preparing a paste containing 1 to 20% by weight of a powdery vegetable protein, 1 to 8% by weight of gellan gum, 0.005 to 0.15% by weight of a divalent metal salt as a divalent metal, and 60 to 95% by weight of water, and molding, heating, and drying the paste.

9. A seafood paste product-like instant food material, which contains a powdery vegetable protein, gellan gum, and a divalent metal and does not contain minced meat.
